(19) United States
(12) Patent Application Publication
(10) Pub. No.: US 2009/0009520 A1
(43) Pub. Date: Jan. 8, 2009

(54) Animation Method Using an Animation Graph

(75) Inventors: Gaspard Breton, Saint Gregoire (FR); David Cailliere, Rennes (FR); Danielle Pele, Thorigne (FR)

Correspondence Address: COHEN, PONTANI, LIEBERMAN & PAVANE LLP, 551 FIFTH AVENUE, SUITE 1210, NEW YORK, NY, 10176, US

(73) Assignee: FRANCE TELECOM, Paris (FR)

(21) Appl. No.: 11/918,286

(22) PCT Filed: Apr. 10, 2006
(86) PCT No.: PCT/FR2006/050325

§ 371 Date: Mar. 10, 2008

(30) Foreign Application Priority Data
Apr. 11, 2005 (FR) 0503596

(51) Int. Cl. G06T 15/70

(52) U.S. Cl. 345/473

(57) ABSTRACT

A method of animating a scene graph (M), which comprises steps for: creating (e1) an animation graph instance (G) comprising animation modules (MA1, . . . , MA10) and composition modules (MC1, . . . , MC4) organized in a tree structure, the animation modules being leaves of subtrees of the graph and the composition modules being used to compose results of their child modules, the latter being either animation or composition modules indiscriminately, and executing (e3) the animation by executing in turn the animation and composition modules of the graph, so that the execution of a composition module uses the results of the executions of its child modules.

The present invention generally relates to the field of image processing, and in particular the animation of graphic scenes using an animation engine.

Furthermore, the invention is geared mainly to the animation of people in three dimensions, but its method can also be used on any other type of two- or three-dimensional graphic scene.

The current animation engines each implement a single animation method, for example a parametric system, a muscular system, or even a system based on key images. Also, in these animation engines, all of the modules needed for the animation, and their interactions, are known in advance and cannot be modified. These animation engines are therefore normally constructed in a single block, in the form of a compiled executable code.

Because of this, when using an animation engine or program on a machine, the latter must have the power required to apply the animation method used. The current animation engines do not indeed make it possible to choose an animation method on starting up the engine, or to adapt the required power to an animation by choosing to animate only an independent subset of a scene or of a person in three dimensions. In particular, they do not make it possible to carry out tests by choosing a particular animation method to animate only a part of a face. Each test requires a different animation engine.

The aim of the present invention is to resolve the drawbacks of the prior art by providing an animation method that acts on a scene graph, a term commonly used to denote a collection of three-dimensional graphic meshes, and an animation graph that can be used to execute different phases of one and the same animation.

To this end, the invention proposes a method of animating a scene graph which comprises steps for:
creating an animation graph instance comprising animation and composition modules organized in a tree structure, the animation modules being leaves of subtrees of the graph and the composition modules being used to compose results of their child modules, the latter being either animation or composition modules indiscriminately,
executing the animation by executing in turn the animation and composition modules of the graph, so that the execution of a composition module uses the results of the executions of its child modules.

The invention makes it possible to reuse the animation modules of one and the same animation engine in different configurations, without needing to code different module assemblies in different programs for each configuration. Thus, the inventive animation engine is adapted to the power of the machine that uses it, by the choice of an appropriate animation method. It also makes it possible to test different animation methods, without recompiling the animation modules of the animation engine on each different configuration test.

The use of an animation graph to produce an animation makes it possible indeed to modify the characteristics of the animation by choosing only the appropriate animation modules, from those that exist and are already compiled in the animation engine.

According to a preferred characteristic of the inventive method, the algorithm used by at least one of said composition modules does not depend on the parts of the mesh on which its child animation modules act.

This means that, when there is a desire to change child animation modules composed by a composition module in the animation graph, this same composition module can be reused, even though the new child animation modules act on different mesh parts to the old child animation modules.

According to a preferred characteristic, the algorithm used by at least one of said composition modules of the graph does not depend on the animation method used by its child modules.

The use of very generic composition modules means that animation modules of different methods can be tested by reusing the same composition modules.

According to a preferred characteristic, the step for creating an animation graph instance entails reading a configuration file describing said animation graph.

Grouping together the characteristics needed to create an animation graph in a configuration file makes it easier to produce different configuration tests. For each configuration test, a configuration file is, for example, defined and can be used to create the animation graph corresponding to this test in the animation engine.

The invention also relates to an animation graph making it possible to execute one or more animation phases by using the inventive method, wherein:
each animation phase is described by a subtree of which it is the root in the animation graph, said subtree comprising animation modules and, where appropriate, composition modules,
in said subtree, the animation modules and any composition modules are organized in a tree structure, the animation modules being leaves of said subtree and the composition modules being used to compose results of their child modules, the latter being either animation or composition modules indiscriminately.

The invention also relates to an animation engine which comprises dynamic configuration means using an inventive animation graph.

The invention also relates to the use of an inventive animation graph to execute an animation, wherein, when the animation graph contains several phases, the latter are executed sequentially.

Finally, the invention also relates to a computer program which comprises instructions for implementing the inventive method, when said program is run in a computer system.

The animation graph, the animation engine and the computer program offer advantages similar to those of the method.

Other characteristics and advantages will become apparent from reading about a preferred embodiment described with reference to the figures in which:

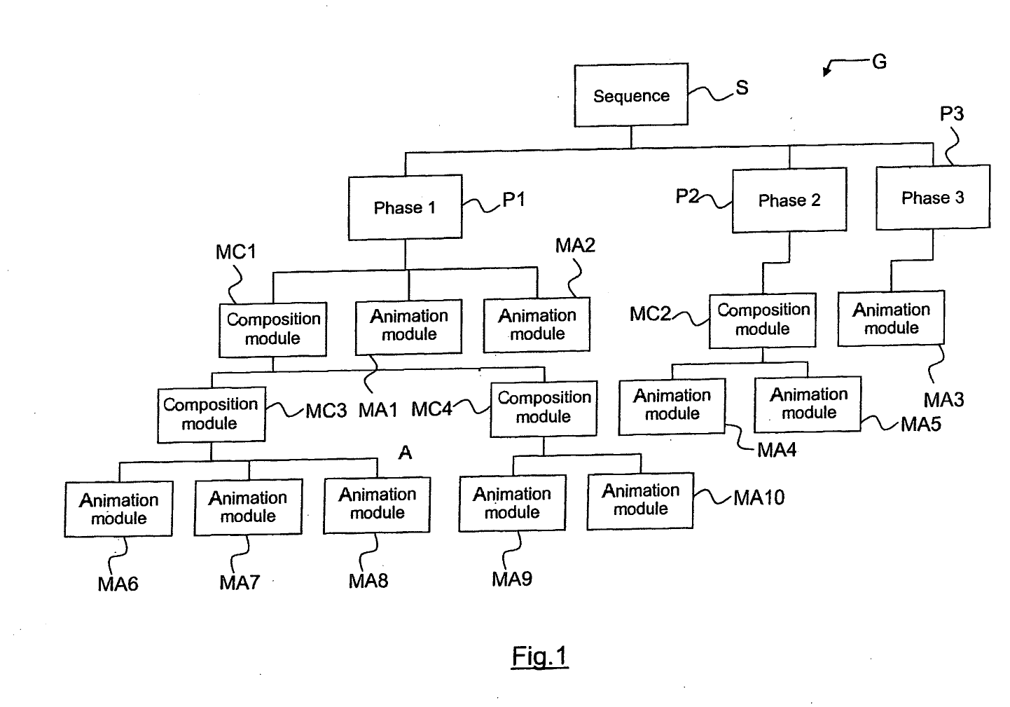

FIG. 1 represents an inventive animation graph,

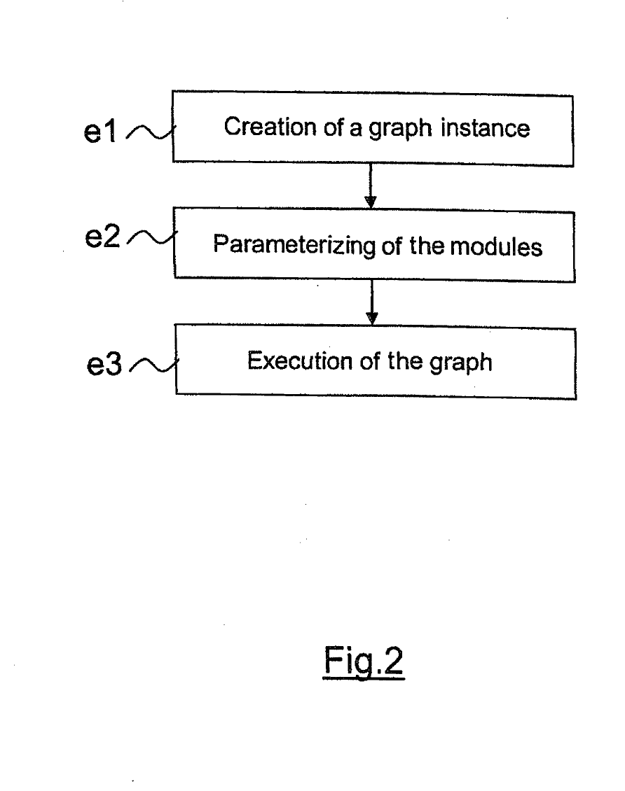

FIG. 2 represents the steps of the inventive method,

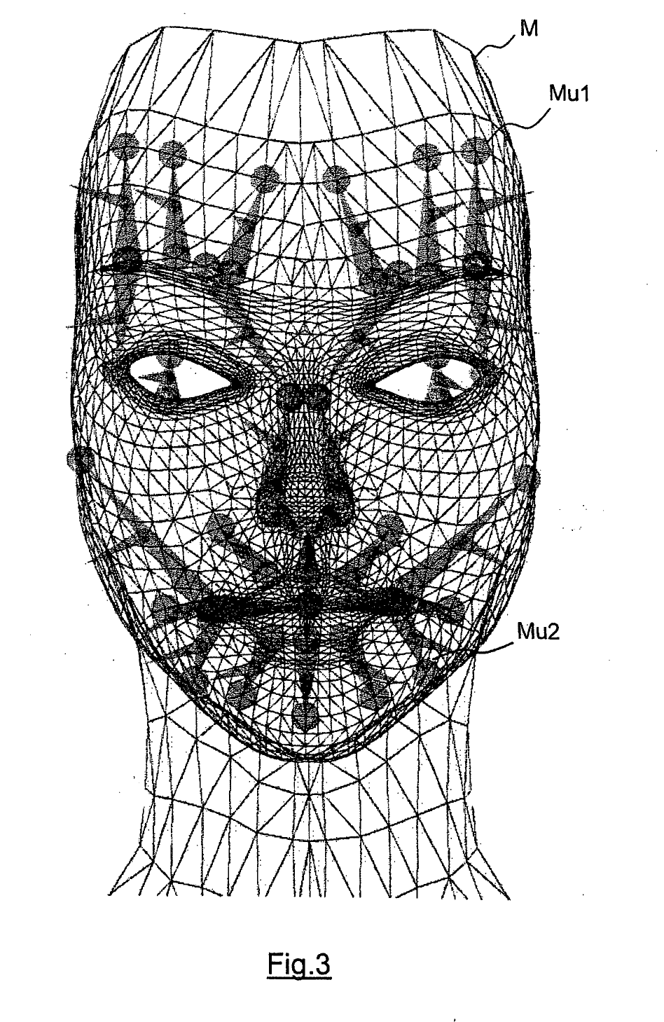

FIG. 3 represents the mesh of a face in three dimensions, intended to be animated,

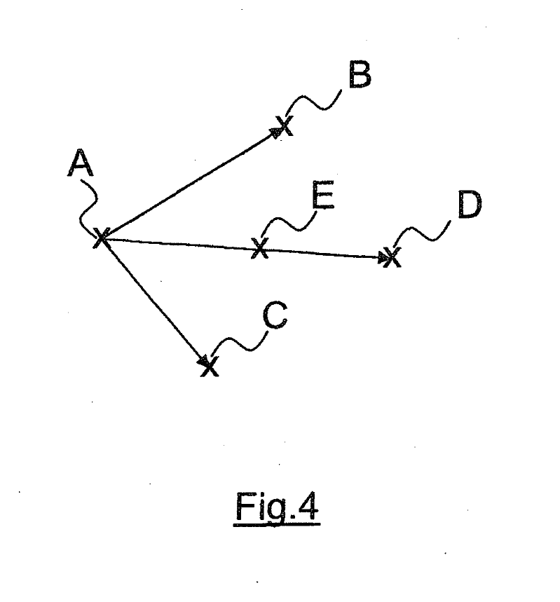

FIG. 4 represents the composition of animation results by a composition module,

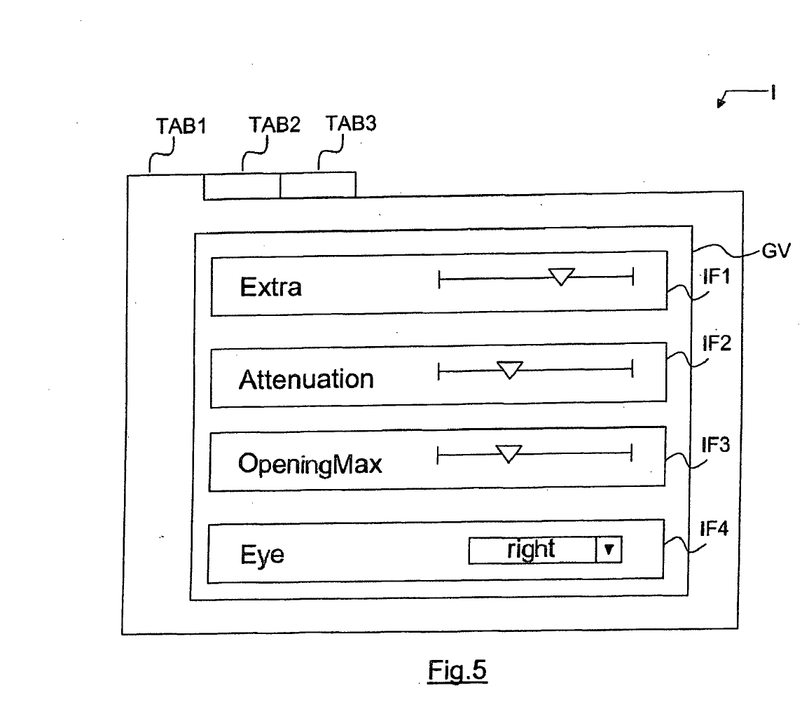

FIG. 5 represents a user interface,

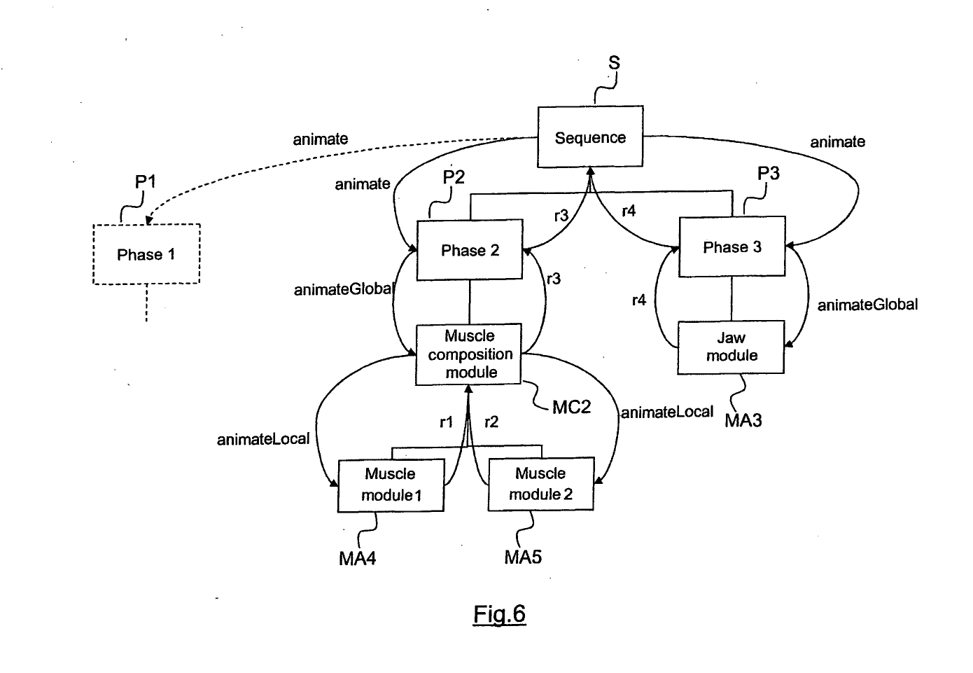

FIG. 6 represents the step for executing the inventive method,

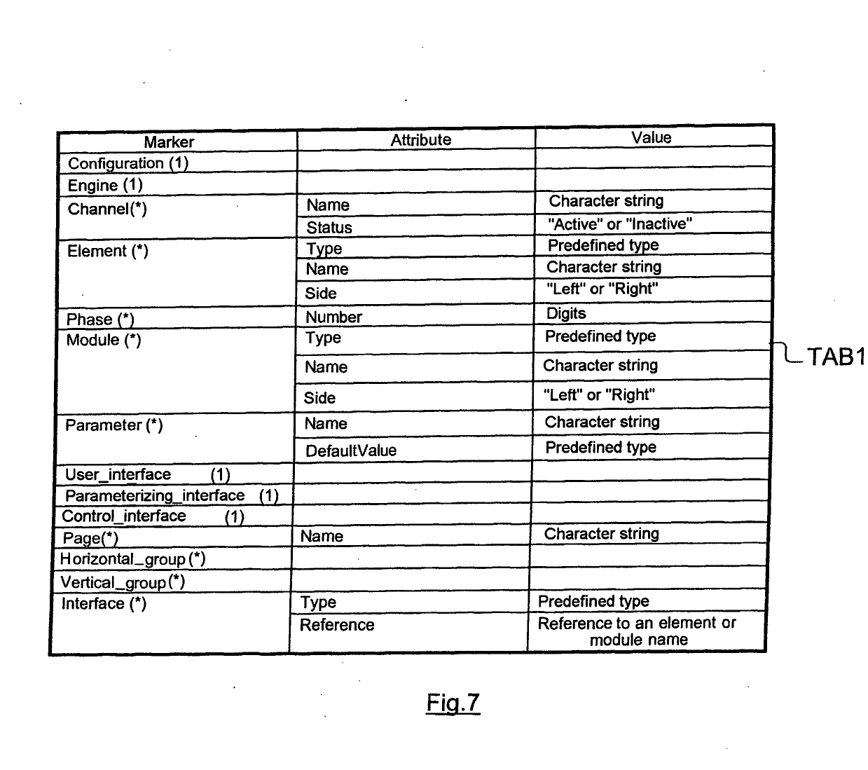

FIG. 7 represents a set of parameters defining an exemplary profile for configuring an animation engine.

According to one embodiment of the invention, the inventive method is implemented in an animation engine as software. The software used has a set of predefined modules of which the instantiation in the form of a tree is controlled by an animation graph. The method makes it possible to configure the animation engine dynamically by using the animation graph. This configuration of the engine, or animation graph, is specified in a configuration file called profile.

The modules of the animation engine are animation and composition modules, intended in this exemplary embodiment to animate a scene graph representing a face in three dimensions. Nevertheless, the inventive method is also applicable to any other type of graphic scene, by using animation and composition modules suited to this other type of scene. These modules are organized in a tree structure in the animation graph G represented in FIG. 1, configured to produce an animation of the face in three dimensions.

When using the animation engine, these modules are normally already compiled from a previous use. The use of the inventive method does not require these modules to be recompiled, even when the configuration of the graph is modified, for example to use animation modules corresponding to an animation method other than the preceding animation modules.

The method comprises three main steps, represented in FIG. 2 and summarized below.

The step e1 is the creation of an animation graph instance corresponding to a configuration of the animation engine. This configuration is selected using a profile, or configuration file, describing the animation graph G, from a set of profiles available in the animation engine. It defines the animation method used and the choice of the corresponding modules to be used. As explained previously, these modules are normally precompiled. The animation engine creates this animation graph instance from reading the selected configuration file. It creates an instance of each module of the graph, and the links defined by the structure of the animation graph G, between these module instances. These links are used in the step for executing the animation.

The next step e2 is the parameterizing of each animation module of the graph with input parameters specific to each of these modules and to the face to be animated, and with control parameters specific to the modules and to the animation itself. These parameters in fact often have to be modified, for example when the animation engine is used on a face other than that on which it was previously used. The parameterizing uses, for example, parameter files giving the values for each face of all the parameters needed for the animation modules of the animation engine, one file for each face being available in the engine. The profile selected in the step e1 also contains default parameters for the animation modules of the animation graph G, which are used in the step e2 to parameterize the animation modules, in the case, for example, where the parameter files are incomplete.

The next step e3 is the execution of the animation. It is used to animate the face in three dimensions by following the indications of the control parameters given in the step e2 for parameterizing the modules of the animation graph.

The parameters of the animation modules, and the execution step e3, will be detailed more fully below.

The structure of the animation graph G, and the different component modules, will now be detailed.

The animation modules are leaves of the tree of the graph G, while the composition modules are parents of animation or composition modules in the tree of the graph G. The tree of the graph G forming the animation engine has the sequence S as its root, which has one or more phases as its daughters, which will be executed sequentially one after the other. In the example of FIG. 1, these phases are the phases P1 to P3. This first level of the tree therefore makes it possible to describe the time aspect of the animation, whereas the subsequent levels describe the organizational aspect of the engine.

Each animation module MA1, MA2, . . . , MA10 is used, in an animation of the face in three dimensions, to animate a part of the three-dimensional mesh which forms this face.

It should be noted that an animation module is specific to a particular animation method, but is not always specific to the part of the mesh on which it acts. In the example of FIG. 3, the animation modules Mu1 and Mu2 that act on the scene graph or mesh M of the face in three dimensions use a muscular animation method. This animation method consists in distorting the vertices of a part of the mesh in a way similar to the distortion that would be provoked by a muscle on the corresponding part of the face, also called area of influence of the muscle. Each module can therefore be likened to a muscle. Thus, the module Mu1 corresponds to a forehead muscle, the operation of which is that of an ordinary muscle, that can also be used on other parts of the face, for example such as risorius muscle, whereas the module Mu2 corresponds to a mouth muscle, the operation of which is more specific, because it must not distort the bottom lip of the face.

The positioning of an animation module on the three-dimensional mesh is determined by input parameters to this module, configured in the step e2 for parameterizing the animation graph. For an animation module that uses a muscular method, these parameters define, among other things, for example, the point of attachment of the muscle to the skull, its point of insertion in the flesh of the face, or even its opening angle.

The animation modules MA1, MA2, . . . , MA10 represented in FIG. 1 therefore make it possible to modify the geometric properties of the three-dimensional mesh by displacing certain vertices, or the colorimetric properties by modifying the materials or the textures used to illuminate the face in three dimensions. Furthermore, an animation module is activated either locally or globally:
A module is activated locally when it acts only on a single vertex of the mesh to modify its position or its calorimetric properties. The result returned by the module then contains the new position of the vertex in the mesh, and, where appropriate, other color or composition parameters.
A module is activated globally when it deals with all the vertices of a mesh at the same time. In this case, the result returned is, for example, a new temporary mesh not containing composition parameters.

The composition modules MC1, MC2, . . . , MC4, represented in FIG. 1, make it possible to compose the results of the animation modules that operate jointly, for example the results of modules corresponding to pseudo-muscles operating simultaneously. A composition module in the graph G composes the results of the animation or composition modules of which it is the parent in the animation graph G.

Thus:
the composition module MC1 can be used to compose the result of the composition modules MC3 and MC4,
the composition module MC2 can be used to compose the result of the animation modules MA4 and MA5,
the composition module MC3 can be used to compose the result of the animation modules MA6, MA7 and MA8,
the composition module MC4 can be used to compose the result of the animation modules MA9 and MA10.

More specifically, a composition module can be used to determine the final distortion resulting from the actions of its child modules on the three-dimensional mesh. The composition algorithm used by this module is implemented independently of the part of the mesh concerned. It consists in practice in a simple weighting of the distortions provoked on the mesh by each of its child modules. The composition parameters supplied by each of the child modules to the composition module can, on the other hand, be specific to the child modules. They can, for example, be specific weighting coefficients.

For example, for the vertex A of the three-dimensional mesh represented in FIG. 4, the local action of the module MA9 provokes the displacement of the vertex A to the position B, whereas the local action of the module MA10 provokes the displacement of the vertex A to the position C. The simple addition of these displacements results in the position D, which is generally unrealistic for the animation of a face. The composition module MC4 uses a weighting algorithm that makes it possible to give as the result of the composition of the actions of the modules MA9 and MA10 on the vertex A, the position E, which is more realistic.

The composition modules therefore use the results of the local actions of each of their child modules. In order to enable the results of a first composition module to be used by a second composition module that is the parent of this first module, the composition modules are activated either locally, or globally, as for the animation modules. When they are activated locally, they return the results of their composition vertex by vertex. The results of the animation modules can thus be referred upward to be used iteratively in the tree structure of the graph G by their different parent modules.

Furthermore, the composition modules are either specific to an animation method, or independent of the animation method used. In the first case, on a change of animation method used, these specific composition modules must be changed in the animation graph G, whereas in the second case only the animation modules must be changed.

In the exemplary embodiment described here, the composition modules are very generic because they simply add together or weight the results of each of their child modules, and are independent of the animation method used.

Moreover, if certain parts of the face operate independently, different animation methods can be used on each of these parts. This entails the use of two different types of animation modules, for example muscular animation modules on one part of the face and animation modules using a morphing technique on the other part of the face.

Different configurations of the animation graph G are created in order to respond to these different uses. For example, in one of these configurations, animation and composition modules are masked in order not to be involved in the animation, although their positions in the organization of the graph are retained for a subsequent animation. The choice of a configuration for a given use is made in the step e1 for configuring the animation engine.

As stated above, the composition modules of the graph G are applied to the animation modules themselves and not to the objects of the three-dimensional scene concerned. This makes it possible to easily reuse the animation graph G on different faces, by modifying only the positioning parameters of the animation modules. These parameters are set in the step e2 for parameterizing the animation graph.

Some of these parameters are numeric values, corresponding, for example, to a point of attachment of a muscle for a muscular module. Other parameters, called elements, are modules that implement detection or preprocessing algorithms on the three-dimensional mesh, needed for certain animation modules. In practice, for example, an animation module which processes the operation of eyelids needs to know where the eyes of the face are situated. The detection of an eye is then implemented in an element. These elements used to perform preprocessing operations or to detect areas of the face in three dimensions are, for example, executed in the step e2 for parameterizing the animation graph G.

Other parameters, also set during the step e2 for parameterizing the animation graph G, are necessary in order to produce the animation. These control parameters, defined statically, are specific to an expression, they make it possible to define, for example for a muscular animation method, the degree of contraction to be applied to the muscle modeled by an animation module, when the face to be animated needs to smile. These different control parameters are grouped together in animation channels. A large number of animation channels can be used, notably, for example, one channel for the movement of the eyes, one channel for the movement of the eyelids, one channel for the emotions, one channel for the emphases, which are conversational markers, or even one channel for speech, more specifically one channel for each language.

The animation graph created and parameterized in this way in the steps e1 and e2 is executed at the moment of animation. Depending on the required animation system and the power of the target machine, the animation graph G is more or less complex and incorporates different elements and animation modules not requiring the same computation power.

In order to facilitate the use of the animation engine, a user interface is implemented in the engine to adjust the parameters of the animation modules, in the step e2 for parameterizing the animation graph G. This interface is used together with or instead of the parameter files used in the step e2. The user interface is divided into two categories, the parameterizing interface and the control interface. The parameterizing interface is used to adapt the animation modules to the virtual person by setting the input parameters of these modules. The control interface is used to adjust the static control parameters of the animation modules that will be used during the step e3 for executing the animation.

It should be noted that this user interface is intended for those skilled in the art using the animation engine according to the invention, and not for an ordinary user who uses another type of interface simply making it possible to define a series of predefined expressions to be played for a given animation. In practice, the ordinary user intervenes only during the execution step e3; by, for example, asking the animation engine to have the face pronounce the word “Hello”. The animation engine then declines the dynamic control parameters needed to pronounce the word “Hello”, by using the static control parameters set by the person skilled in the art in the step e2 for parameterizing the animation graph G. For this, it uses, for example, a voice synthesis system, which breaks down the word “Hello” into phonemes, each phoneme having one or more associated static control parameters, and deduces the dynamic control parameters to be applied to the face between two phonemes by an interpolation using the static control parameters associated with each of these two phonemes.

The user interface therefore makes it possible to set the input parameters of the modules and the control parameters related to the corresponding animation modules of the animation engine. For this, each category of interface is organized in pages in order to be able to group together the parameters in a practical form. The pages are organized in one or more horizontal or vertical groups of graphic objects each used to describe and set a parameter. These groups can be described recursively. For example, a vertical group can be made up of several horizontal groups.

Thus, in the example of FIG. 5, the parameterizing interface I is made up of three graphic pages TAB1 to TAB3. The first page TAB1 contains a vertical group GV of four graphic objects:
The graphic object IF1 is used to set the input parameter “Extra” of an eyelid animation module. This parameter defines the position of the eyelid relative to the radius of the eye.
The graphic object IF2 is used to set the input parameter “Attenuation” of the same module. This parameter defines the attenuation of the movement of the vertices of the eyelid when it opens.
The graphic object IF3 is used to set the input parameter “OpeningMax” of the same module, defining the maximum opening of the eyelid in the animation.
The graphic object IF4 is used to supply the eyelid animation module with a detection element “Eye” corresponding either to the right eye or to the left eye of the face in three dimensions.

The step e3 for executing the animation graph G will now be detailed. Once the parameterizing step e2 has been completed, the animation is run in the step e3 for executing the animation graph G. The execution of the animation graph G calls the “animate” function of the root sequence S of the tree of the animation graph G. This execution consists in working through the animation graph in order to produce the desired animation. The control parameters of each animation module are applied to the corresponding module in this animation, to produce the expressions that are sent as instructions to the engine during the execution step e3.

It should be noted that each animation channel supplies its own control parameters. In the execution step e3, these parameters are mixed according to a so-called “mixing” technique which makes it possible to coordinate the different distortions of the face due to each animation channel, in order to obtain a coherent animation. The animation modules thus receive only one set of control parameters, as if a single animation channel had been defined. For example, for a muscular animation method, an animation module receives only a single muscle contraction value that it represents at a time.

The operation of the execution step e3 is represented in FIG. 6. The “animate” function applied to the sequence S calls in turn the “animate” functions of the daughter phases of the sequence S, that is, in this exemplary embodiment, the “animate” functions of the phases P1 to P3, in order to execute them sequentially. For greater clarity, the operation of the animation of phase P1 is not represented in FIG. 6.

Each phase P1 to P3 has the list of their child modules, and activates them by the “animateGlobal” function. The “animateGlobal” function is used to activate an animation or composition module globally, whereas the “animateLocal” function is used to activate an animation or composition module locally.

For the animation modules, the “animateLocal” function contains the desired animation algorithm and works only on a single vertex. It therefore returns the individual result of its action consisting of the new position of the vertex and a set of parameters useful for the composition, for example weighting parameters. The “animateGlobal” function performs an iteration of the “animateLocal” function on all the vertices of the area of influence of the animation module.

Similarly, the “animateLocal” function of a composition module works only on a single vertex, but begins by calling the “animateLocal” function of its child modules, which are composition or animation modules. Then, the function applies the desired composition algorithm and returns the result. The “animateGlobal” function of a composition module performs an iteration of the “animateLocal” function on all the vertices to be composed by the composition module.

The “animate” function applied to the phase P2 therefore provokes the animation of its child module MC2 by calling the “animateGlobal” function, and the “animate” function applied to the phase P3 provokes the animation of its child module MA3 by calling the “animateGlobal” function. It should be noted that the phases are not composition modules, and are executed sequentially one after the other taking account of the mesh distorted by the preceding animation phase. The child modules of a phase are therefore used to compute the intermediate meshes used in the animation, and are activated globally.

The composition module MC2, when the “animateGlobal” function is called, in turn calls the “animateLocal” function on its child modules, which are the animation modules MA4 and MA5. For each of the vertices of their respective areas of influence, the modules MA4 and MA5 then each apply their animation algorithm taking account of their input parameters, and their mixed control parameters to take account of the action of each of the animation channels. The modules MA4 and MA5 return for each vertex in turn the results r1 and r2 of their actions and parameters useful for the composition, to their parent module MC2.

On receiving the results supplied by the modules MA4 and MA5, the composition module MC2 applies its composition algorithm to each of the vertices in the areas of influence of the modules MA4 and MA5, and returns the global results r3 of this composition to the phase P2. Finally, the phase P2 transmits these results r3 to the sequence S.

The animation module MA3, when the “animateGlobal” function is called, applies its animation algorithm taking into account its input parameters, and its control parameters, which are mixed to take account of the action of each of the animation channels, on all the vertices of its area of influence. It returns the results r4 of its actions on these vertices to the phase P3, which transmits them to the sequence S.

The results of the actions of animation or composition modules transmitted by the phases to the sequence S enable the animation engine to play the animation. For this, the results of the phases are used phase by phase to distort the mesh of the face. The distortions of the mesh due to the current phase are taken into account by the animation engine to compute the distortions of the mesh in the next phase. In particular, if the first phase, for example, induces a movement of the eyelids, and the second phase a movement of the head, the engine will combine these two movements.

An exemplary profile needed to enable the animation engine to produce the animation of the face in three dimensions is represented in table TAB1 of FIG. 7. This profile is produced in the XML language, XML being an abbreviation of “eXtensible Markup Language”. The first column gives the name of the XML marker described on the line concerned, the second column specifies the attributes associated with this marker, and the third column specifies the value to be given to these attributes.

Thus:
The “Configuration” marker is used to describe all the configuration of the animation engine, itself containing the optional markers “Engine” and “User_interface”.
The “Engine” marker is used to describe the engine and contains the mandatory markers “Channel”, “Phase” and “Element” respectively used to describe an animation channel, a phase and a detection or preprocessing element on a three-dimensional face mesh. For a given animation, a number of these markers are present according to the number of animation channels, phases and elements needed for the animation.
The “Channel” marker is used to specify the animation channels of the animation engine that will be active. The first attribute of this marker, “Name”, is used to give a name to the channel. For example, for the facial animation, the following channel names are used:
   “ManipReplay” denotes a manipulator channel used to replay an animation,
   “ManipNeck” denotes a manipulator channel used to control the head,
   “ManipEyes” denotes a manipulator channel used to control the eyes,
   “ManipEyelids” denotes a manipulator channel used to control the eyelids,
   “ExpEmotion” denotes an expression channel used to control the emotions,
   “ExpMood” denotes an expression channel used to control the moods,
   “ConvMarker” denotes an expression channel used to activate conversational markers,
   “VisemeFrench” denotes a speech channel for French,
   “VisemeEnglish” denotes a speech channel for English,
   “VisemeSpanish” denotes a speech channel for Spanish.
The second attribute, “Status”, is used to specify the initial state of the channel, that is, whether it is activated or not.
The “Element” marker is used to create instances of elements. This marker is made up of the following attributes:
   The “Type” attribute specifies the type of element used, for example an eye detection element. This, type is to be correlated with the elements actually implemented in the animation engine.
   The “Name” attribute gives a name to the instance of the element that will be created by the animation engine, which is used to identify it in order to refer to it.
   The optional “Side” attribute specifies the right or left side of the face to be taken into account for this element instance, if appropriate.
The “Phase” marker is used to specify the phase referred to. It has only a single attribute, “Number”, which is the phase number in the time sequence of the animation. The “Phase” marker contains one or more “Module” markers corresponding to its child modules.
The “Module” marker is used to specify the module used. This can be either an animation module, or a composition module. The “Module” marker itself contains one or more “Module” markers corresponding to its child modules when it represents a composition module, or none if it represents an animation module. It can also contain a list of “Parameter” markers. The “Module” marker has the following attributes:
   The “Type” attribute specifies the type of the module used. This type is to be correlated with the modules actually implemented in the animation engine. It can be, for example, a “Muscle” type module, which is an animation module using a muscular animation method not specific to a part of the face.
   The “Name” attribute gives a name to the instance of the module that will be created by the animation engine, which is used to identify it in order to refer to it.
   The optional “Side” attribute specifies the right or left side of the face to be taken into account for this module instance, if appropriate.
The “Parameter” marker is used to give default values to certain parameters of the module. The first attribute of this marker, “Name”, specifies the name of the parameter and the second attribute, “DefaultValue”, contains the default value to be used if a corresponding value is not supplied in the parameterizing step e2.
The “User_interface” marker is used to describe the user interface of the engine, itself containing the optional “Parameterizing_interface” and “Control_interface” markers.
The “Parameterizing_interface” marker is used to describe the parameterizing interface. For this, it contains one or more optional “Page” markers, or simply a “Horizontal_group” marker or a “Vertical_group” marker if all the input parameters of the modules can be displayed on a single graphic page.
The “Control_interface” marker, similarly, is used to describe the control interface. It contains one or more optional “Page” markers, or simply a “Horizontal_group” marker or a “Vertical_group” marker if all the control parameters can be displayed on a single graphic page.
The “Page” marker is used to specify a graphic page in the control interface or in the parameterizing interface. This marker contains only a single “Name” attribute which gives the name to the duly specified graphic page. It also contains a “Horizontal_group” marker or a “Vertical_group” marker, that can themselves contain other “Horizontal_group” or “Vertical_group” markers, which provides for a large number of possible arrangements of the page. The “Vertical_group” or “Horizontal_group” markers in fact respectively specify the vertical or horizontal groups of graphic objects enabling a user to set module control or input parameters.
The “Horizontal_group” marker therefore contains one or more “Interface” markers each of which represents a graphic object. The graphic objects described in this way will be arranged horizontally. As indicated above, the “Horizontal_group” marker can itself contain, instead of or in addition to this list of graphic objects, one or more “Horizontal_group” or “Vertical_group” markers.
The “Vertical_group” marker, similarly, contains one or more “Interface” markers representing graphic objects that will be arranged vertically. The “Vertical_group” marker can itself contain, instead of or in addition to this list of graphic objects, one or more “Horizontal_group” or “Vertical_group” markers.
Finally, the “Interface” marker is used to specify a graphic object to be used. This marker contains two attributes. The first “Type” attribute defines a type of graphic object. This type must be correlated with the graphic objects predefined in the graphic interface system. In practice, for each module type or specific module, one or more graphic objects are implemented, for example drop-down lists or cursors, used to set the parameters of the module. The second attribute, “Reference”, contains the name of the element or module instance that the graphic object must control.

The XML grammar, or DTD standing for “Document Type Definition”, of the duly defined profile is reproduced in appendix 1.

An exemplary profile using this grammar is also reproduced in appendix 2.

<!-- Root element -->
<!ELEMENT Configuration (Engine?, User_interface?)>

<!-- Engine element -->
<!ELEMENT Engine (Channel*, Element*, Phase*)>

<!-- Channel element -->
<!ELEMENT Channel EMPTY>
<!ATTLIST Channel Name

(ManipReplay|ManipNeck|ManipEyes|ManipEyelids|ExpEmotion|ExpMood|
ConvMarker|VisemeFrench|VisemeEnglish|visemespanish) #REQUIRED>

<!ATTLIST Channel Status (Active|Inactive) #REQUIRED>
<!-- Element element -->
<!ELEMENT Element EMPTY>
<!ATTLIST Element Type (ZoneLowerLip|Eye) #REQUIRED>
<!ATTLIST Element Name CDATA #REQUIRED>
<!ATTLIST Element Side (Left|Right) #IMPLIED>
<!-- Phase element -->
<!ELEMENT Phase (Module*)>
<!ATTLIST Phase Number CDATA #REQUTRED>

<!-- Module element >
<!ELEMENT Module (Parameter*,Module*)>
<!ATTLTST Module Type

(Jaw|Neck|Eye|Eyelid|Cheek|Teeth|wrinkles|CompMuscleAdd|CompMuscle
Conj|Muscle|MuscleLow|MuscleHigh|MuscleOO|MuscleOOF|Keyframe)
#REQUIRED>

<!ATTLIST Module Name CDATA #REQUIRED>
<!ATTLIST Module Side (Left|Right) #IMPLIED>
<!-- Parameter element -->
<!ELEMENT Parameter EMPTY>
<!ATTLIST Parameter Name CDATA #REQUIRED>
<!ATTLIST Parameter DefaultValue CDATA

#REQUIRED>

<!-- User_interface element -->
<!ELEMENT User_interface

(Parameterizing_interface?, Control_interface?)>

<!-- Parameterizing interface and Control interface

elements >

<!ELEMENT Parameterizing_interface

(Page*|Horizontal_group|vertical_group)>

<!ELEMENT Control_interface

(Page*|Horizontal_group|vertical_group)>

<!-- Page element >
<!ELEMENT Page (Horizontal_group|vertical_group)>
<!ATTLIST Page Name CDATA ·REQUTRED>

<!-- Horizontal_group and vertical_group

elements >

<!ELEMENT Horizontal_group

(Interface|Horizontal_group|vertical_group) *>

<!ELEMENT vertical_group

(Interface|Horizontal_group|vertical group) *>

<!--Interface element -->

<!ELEMENT Interface EMPTY>
<!ATTLIST Interface Type CDATA #REQUIRED>
<!ATTLIST Interface Reference CDATA

#REQUIRED>

1. A method of animating a scene graph (M) which comprises steps for:
creating (e1) an animation graph instance (G) comprising animation modules (MA1, MA10) and composition modules (MC1, . . . , MC4) organized in a tree structure, the animation modules being leaves of subtrees of the graph and the composition modules being used to compose results of their child modules, the latter being either animation or composition modules indiscriminately,
executing (e3) the animation by executing in turn the animation and composition modules of the graph, so that the execution of a composition module uses the results of the executions of its child modules.

2. The method of animating a scene graph (M) as claimed in claim 1, wherein the algorithm used by at least one of said composition modules does not depend on the parts of the mesh on which its child animation modules act.

3. The method of animating a scene graph (M) as claimed in claim 1, wherein the algorithm used by at least one of said composition modules of the graph does not depend on the animation method used by its child modules.

4. The method of animating a scene graph (M) as claimed in claim 1, wherein the step (e1) for creating an animation graph instance (G) entails reading a configuration file describing said animation graph.

5. An animation graph (G) making it possible to execute one or more animation phases (P1, . . . , P3) by using the animation method as claimed in claim 1, wherein:
each animation phase is described by a subtree of which it is the root in the animation graph, said subtree comprising animation modules and, where appropriate, composition modules,
in said subtree, the animation modules and any composition modules are organized in a tree structure, the animation modules being leaves of said subtree and the composition modules making it possible to compose results of their child modules, the latter being either animation or composition modules indiscriminately.

6. An animation engine which comprises dynamic configuration means using an animation graph as claimed in claim 5.

7. The use of an animation graph (G) as claimed in claim 6 to execute an animation, wherein, when the animation graph contains several phases (P1, . . . , P3), the latter are executed sequentially.

8. A computer program which comprises instructions for implementing the method as claimed in claim 1, when said program is run in a computer system.

9. The method of animating a scene graph (M) as claimed in claim 2, wherein the algorithm used by at least one of said composition modules of the graph does not depend on the animation method used by its child modules.

10. The method of animating a scene graph (M) as claimed in claim 2, wherein the step (e1) for creating an animation graph instance (G) entails reading a configuration file describing said animation graph.

11. The method of animating a scene graph (M) as claimed in claim 3, wherein the step (e1) for creating an animation graph instance (G) entails reading a configuration file describing said animation graph.
